(19) United States
(12) Patent Application Publication
(10) Pub. No.: US 2024/0369723 A1
(43) Pub. Date: Nov. 7, 2024

(54) RADIATION DETECTION

(71) Applicant: MBDA UK LIMITED, Stevenage Hertfordshire (GB)

(72) Inventors: Edwin John William BOWDEN-PETERS, Stevenage Hertfordshire (GB); Benjamin James COOK, Stevenage Hertfordshire (GB)

(21) Appl. No.: 18/291,467

(22) PCT Filed: Jul. 8, 2022
(86) PCT No.: PCT/GB2022/051773

§ 371 Date: Jan. 23, 2024

(30) Foreign Application Priority Data
Jul. 23, 2021 (GB) 2110711.5

(51) Int. Cl. G01T 1/24

(52) U.S. Cl. CPC G01T 1/247

(57) ABSTRACT

A radiation detector is disclosed. The detector comprises: a conversion device configured to develop a voltage when subject to incident radiation; and a switch operable configured to move between a first state and a second state when triggered by a threshold voltage. The conversion device is connected to the switch such that, when the threshold voltage is developed across the conversion device, the switch is triggered to move from the first state to the second state. The detector further comprises an interrogation circuit operable to determine whether the switch is in the first state or the second state, thereby to determine whether the detector has been subjected to a threshold level of radiation associated with the threshold voltage. A system comprising radiation sensitive apparatus and the radiation detector is also disclosed.

### FIELD

The present invention relates to a radiation detector, and to systems comprising radiation detectors. More particularly, though not exclusively, the invention relates to radiation detectors for use in determining whether or not a particular threshold limit of radiation exposure has been exceeded over an extended period of time.

### BACKGROUND

Many systems are known to be damaged by exposure to ionising radiation, such as alpha, beta or gamma radiation; cosmic radiation including a variety of different types of radiation; or x-rays. Such ionising radiation can damage electronic components, and in some cases can cause damage to materials. Devices such as mobile phones or computers can be vulnerable to radiation damage; and damage to structural materials can have serious consequences for products if the damage is severe enough to result in structural failure.

It is desirable to be able to identify quickly and securely whether or not a system has been exposed to a level of radiation that may cause damage or malfunction, so that appropriate action can be taken prior to a system being used.

### SUMMARY

According to an aspect of the present invention, there is provided a radiation detector comprising: a conversion device configured to develop a voltage when subject to incident radiation; a first switch configured to move between a first state and a second state when triggered by a threshold voltage; wherein the conversion device is connected to the switch such that, when the threshold voltage is developed across the conversion device, the switch is triggered to move from the first state to the second state; and an interrogation circuit operable to determine whether the switch is in the first state or the second state, thereby to determine whether the detector has been subjected to a threshold level of radiation associated with the threshold voltage.

The switch may be a MEMS switch. MEMS refers to micro electro-mechanical systems. Such systems have components of a size in the micrometre range. As used herein, MEMS also includes systems having components of a size in the nanometre sometimes referred to as NEMS. MEMS switches can be made to be highly robust, able to withstand both high temperatures as well as being radiation hard.

The switch may comprise a latching circuit. Alternatively the switch may comprise a relay circuit.

The conversion device and the switch may be operable without any further source of electrical power, and the interrogation circuit may be operable, when connected to a source of electrical power, to determine whether the detector has been subjected to the threshold level of radiation whilst the interrogation circuit has not been connected to electrical power. The lack of any need for electrical power enables the radiation detector to be used for long periods of time, for example in association with radiation sensitive apparatus, and interrogated only when the apparatus is to be used. This can be beneficial where the apparatus is to be stored for long periods of time, or where it is difficult to provide a power supply. Detectors in which no power is required for operation in this way, at least up until the point at which the interrogation circuit is operated, can be referred to as passive radiation detectors.

Where the switch comprises a latching circuit or relay, a small amount of electrical power may be required, but this may be provided for example using solar power, or using power from the apparatus itself should that be convenient.

The radiation detector may further comprise a second switch configured to move between a first state and a second state when triggered by a threshold voltage, the second switch being connected to the conversion device via the first switch when the first switch is in the second state; and the detector may further comprise a second interrogation circuit operable to determine whether the second switch is in the first state or the second state. As is explained in further detail below, such an arrangement enables the duration of exposure to radiation to be determined. It will be appreciated that the detector may further comprise a third switch, similarly connected to the second switch, and may comprise yet further switches. The number of switches may be selected in dependence on the duration of expected radiation exposure; or the duration of radiation exposure it is desirable to detect.

The invention extends to apparatus comprising a plurality of radiation detectors as described above. Each of the plurality of radiation detectors may configured to have a different threshold voltage. Alternatively, each of the plurality of radiation detectors may be configured to have the same threshold voltage.

The apparatus may further comprise a processor in communication with the interrogation circuits of the or each radiation detector, and configured to determine further characteristics of the radiation exposure in dependence on the switch states determined by the interrogation circuits. The further characteristics may comprise one or more of the duration of the exposure to radiation, and the type of radiation.

The invention further extends to a system comprising the radiation detector or apparatus as described above, and radiation sensitive apparatus, the system being configured to alert an operator if the interrogation circuit determines that the radiation detector has been subject to the threshold level of radiation. Alternatively, the system may be configured such that, if the interrogation circuit determines that the radiation detector has been subject to the threshold level of radiation, the radiation sensitive apparatus is disabled.

The radiation detector may be located adjacent to the radiation sensitive apparatus. Preferably, the radiation detector may be located on an external side of the radiation sensitive apparatus.

### BRIEF DESCRIPTION OF THE FIGURES

Embodiments of the invention will now be described by way of example only with reference to the figures, in which:

FIG. 1 is an illustration of a radiation detector in accordance with a first embodiment of the invention;

FIG. 2 shows further detail of a component part of the radiation detector of FIG. 1;

FIG. 3 is an illustration of a radiation detector in accordance with a second embodiment of the invention; and

FIG. 4 is an illustration of a system including a radiation detector.

### DETAILED DESCRIPTION

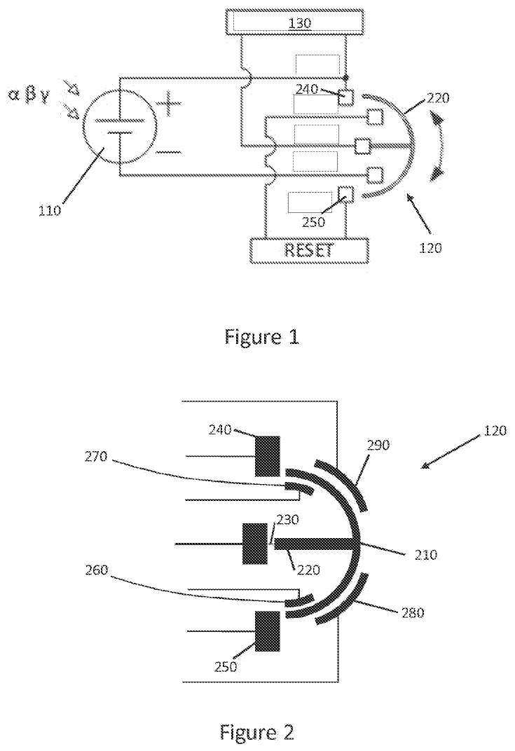

FIG. 1 is a schematic illustration of a radiation detector 100. In broad terms, the radiation detector comprises a conversion device 110, a switch 120, and an interrogation circuit 130. The conversion device operates to convert incident ionising radiation into an electrical signal. Radiation incident on the conversion device causes a voltage to develop across the conversion device. The switch 120 is connected to the conversion device, and is triggered to move from a first state to a second state when the voltage across the conversion device reaches a threshold level. Since the voltage across the conversion device depends in a known manner on its exposure to radiation, the threshold voltage will be reached once the conversion device has been exposed to a certain, threshold radiation level. Thus the switch is triggered once the threshold radiation exposure level is reached.

The interrogation circuit is used to determine whether or not the switch has been triggered, and thus whether or not the device has been exposed to the threshold level of radiation. Typically, the radiation detector in use will be associated with some radiation sensitive apparatus—such as a computing device, or an apparatus having key structural elements fabricated from a radiation sensitive material—and the interrogation circuit can be operated at the time at which it is desired to operate the apparatus. It is possible that this will be some time after the actual exposure to radiation has taken place. However the radiation detector 100 enables it to be determined whether or not the apparatus has been exposed to a potentially damaging level of radiation, regardless of whether that level of exposure was recent.

The conversion device 110 includes a semiconductor p-n junction. Ionising radiation passing through the junction interacts with the semiconductor material to create electron-hole pairs. As is generally understood, electrons in the junction are biased towards one side of the junction, whilst holes are biased towards the other, so that a potential difference between the two sides of the junction develops in dependence on the number of electron-hole pairs created. Since the number of pairs created is dependent on the energy of the incident radiation, the voltage developed can be related to the exposure of the junction to ionising radiation. The semiconductor material used can be chosen in dependence on the particular type or energy levels of ionising radiation it is desired to take. Moreover, dopants and doping levels of the semiconductor material can be chosen to alter the bandgap of the device, and therefore also to exert some control over the response of the device to incident ionising radiation. Thus it will be appreciated that the radiation detector can be modified in a number of ways so as to achieve the appropriate response to the type and energy of radiation it is desired to detect.

Many different semiconductor materials can be used, with those having a higher bandgap expected to be more appropriate. The band structure and band gap can be altered through changing the material used, the dopant, and the concentration of dopant in the semiconductor material. In the present example, a gallium arsenide is used. Some alternative examples include silicon carbide, gallium nitride, and diamond.

Switch 120 is a MEMS switch. MEMS will be understood to relate to micro-electro-mechanical systems, or electro-mechanical systems in which the component parts are of a size in the micrometre range or nanometre range. Switch 120 is shown in further detail in FIG. 2, and in the present example is of the type disclosed by Rana et al. in ‘Nanoelectromechanical relay without pull-in instability for high-temperature non-volatile memory’ in Nature Communications (2020) 11:1181. Switches designed for use in non-volatile memory have the desirable property that the switch state is retained when power is removed. Switch 120 comprises an arcuate beam 210, having a further beam 220 extending towards a centre of curvature of the arcuate beam. The further beam is anchored via hinge 230. In FIG. 2, switch 120 is shown in its neutral state, with a small gap between either end of the arcuate beam 210 and a respective terminal 240, 250. Principal gates 260, 270, located internally of the arcuate beam 210, and auxiliary gates 280, 290, located externally of the arcuate beam 210, enable an electrostatic voltage to be applied to the arcuate beam so as to bias it towards one or other of the terminals 240, 250. When the threshold voltage is reached, the beam 210 will contact one of the terminals 240, 250. Absent a further applied force to remove the beam from the terminal, such as an opposing voltage, the beam will remain in contact with the terminal. Switch 120 does not require any further source of electrical power in order to operate. In some cases it may be desirable for the arcuate beam and contacts to be metal plated so as to improve their electric characteristics. As per Rana et al., plating with Cr—Au can also be used to alter the properties of the switch, such that, once contact is made, the arcuate beam is cold-welded to the contact. For the present application this provides a highly robust means of detecting exposure to the threshold radiation level.

Referring to FIG. 1, conversion device 110 is connected across terminal 240 and gate 270 of the switch 120. This voltage results in an electrostatic force biasing the beam 220 towards terminal 240. If the conversion device exposure to radiation is sufficient for the threshold voltage to be reached, beam 220 contacts terminal 240. Interrogation circuit 130 is thus closed. The state of the interrogation circuit can be detected at any appropriate later time so as to determine whether the detector has been subjected to the threshold radiation level.

Radiation detector 100 may be used, by way of example, for determining whether or not a system has been exposed to cosmic radiation during transit. Electronic equipment can be sensitive to cosmic radiation, and in some cases a system including such equipment can malfunction if exposed to even a single ionising particle of sufficient energy. Silicon-based devices, for example, are vulnerable to corruption or soft errors if exposed to cosmic radiation, or to energetic secondary particles. This can be a particular problem for aircraft systems, or for systems transported by aircraft, since the incidence of cosmic radiation is more frequent at high altitude. It can also be a problem for systems that are kept in storage over long periods of time, for which the risk of exposure is increased simply as a result of the length of time for which the system is stored.

Radiation detector 100 can be incorporated into such a system, allowing a determination to be made after transit, or after storage, as to whether or not the system is safe to use; or as to the likely risk of a malfunction occurring as a result of exposure to cosmic radiation. A system 400 comprising radiation detector 100 is illustrated in FIG. 4. The radiation detector 100 is placed adjacent a processor 420 of concern in the system, so that detector 100 is exposed to approximately the same level of radiation as the processor of concern. As shown in the present embodiment, detector 100 can be located on top of the processor of concern, orientated so as to face the direction of expected incident radiation, so as to make it most likely that any radiation reaching the processor has also passed through the detector 100. Generally it will be desirable for detector 100 to be located on an external side of the processor of concern, since, were detector placed on an internal side, it is possible that damaging radiation may be absorbed by the processor of concern, or that the detector may to some extent be shielded from the radiation exposure. In some examples the conversion material may be extended to cover all, or at least a substantial part, of a processor of concern. The conversion material may in such a case be formed like an umbrella covering the processor of concern. In this way any trigger event can be directly related to ionising radiation incident on the processor of concern, rather than being inferred from proximity.

Use of the radiation detector 100 obviates any need to monitor radiation throughout transit, or across long periods of time whilst a system is stored. A number of radiation detectors can be incorporated in the system, each detector being configured to detect the same radiation type and energy, so as to increase the confidence in the determined radiation exposure level.

Once the system is ready to be used, after transit and/or storage, the interrogation circuit is operated to determine whether or not the radiation detector has been exposed to the threshold level of radiation. In the event that it is determined that the detector has been exposed to the threshold level of radiation, or to a greater level, by determining through the interrogation circuit that the switch has been triggered, the system may be configured to perform an action automatically, without additional operator input. For example, the system may alert an operator through an alarm. Alternatively, for example for safety-critical systems, the system may automatically shut down; or the system may perform a memory reconfiguration or check, or other diagnostics so as to confirm normal functioning.

A number of radiation detectors similar to radiation detector 100, but using different conversion materials in the conversion device, can be combined in a system so as to better characterise the type of radiation to which a system has been exposed. Different conversion materials will respond differently to different types and energies of incident radiation, and the switch 120 can be configured to trigger at different voltages. Thus, for example, a system may comprise a first detector and a second detector. The first detector may be configured to trigger at a first threshold voltage, and a second detector may be configured to trigger at a second, higher threshold voltage. If, on interrogation of the radiation detectors, it is determined that the first detector has been triggered, but the second has not, it can be inferred that the exposure of the system to radiation has been between the level associated with the first threshold voltage, and the level associated with the second threshold voltage.

Alternatively, the first detector may be configured to respond to a first type of ionising radiation, such as beta particles, but not to a second type of ionising radiation, such as gamma radiation; and the second detector may be configured to respond to the second type of radiation, but not to the first type of radiation. In this way it can be determined whether or not the system has been exposed to the first type of radiation, but not the second; the second type of radiation, but not the first; to both types of radiation; or to neither type of radiation. This information can be used to infer whether or not a system has been exposed to cosmic radiation. Typically, cosmic radiation might be expected to include beta particles, but not gamma radiation. From this it can be inferred, for example, that the system has been exposed to a source of radiation other than cosmic radiation.

A plurality of detectors can be used in a system so as to ensure confidence in the result of the determination of whether or not the system has been exposed to radiation. The detectors may be positioned at different points on the system, particularly if the system is susceptible to radiation damage across a large part of its area; or may be packaged in a single device.

A system comprising a plurality of radiation detectors may further comprise a processor in communication with each of the plurality of radiation detectors. The processor may for example be a standard computer, or may be a specifically designed microprocessor. The processor is programmed to operate each of the interrogation circuits of the radiation detectors and provide an output to a user, indicating for example which of the radiation detectors have been triggered, or providing further information inferred which radiation detectors have been triggered

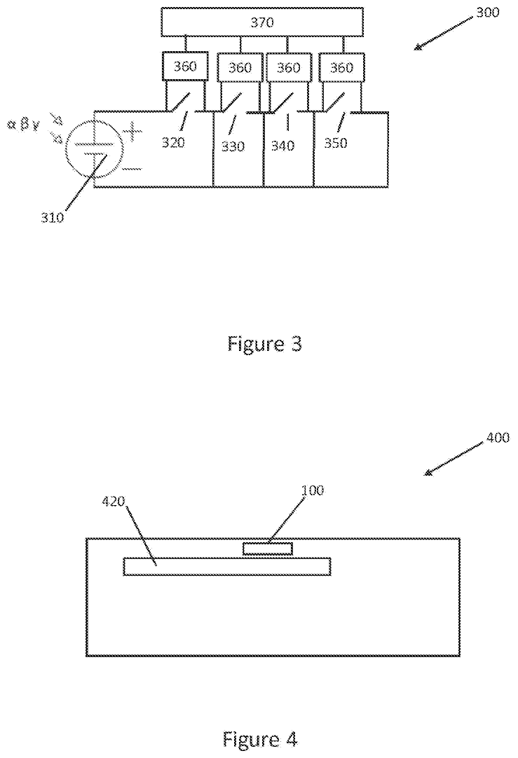

A radiation detector 300 according to an embodiment of the invention is illustrated schematically in FIG. 3. Detector 300 is similar to detector 100 except in that detector 300 comprises a plurality of switches 320, 330, 340, 350. Switches 320, 330, 340, and 350 may each be of the same type as switch 120. As with detector 100, detector 300 comprises a conversion device 110. Conversion device 310 may be the same as conversion device 110, and is connected to switch 320 so that, as with detector 100, once the threshold voltage is developed across the conversion device 310, switch 320 is triggered to move from a first state to a second state. In the present embodiment, the first state of switch 320 is an open state, and the second state is a closed state. In the closed state, the voltage across the conversion device drops. The closed state also connects switch 330 to the conversion device. Thus, should the threshold voltage be reached across the conversion device again, switch 330 is triggered to move from its first, open state to its second, closed state. This results in the voltage across the conversion device dropping again, and in switch 340 being connected to the conversion device. Switches 340 and 350 are similarly connected to the conversion device, switch 340 being triggered once the threshold voltage is reached for a first time after switch 330 is triggered, and switch 350 being triggered once the threshold voltage is reached for a second time after switch 330 is triggered.

Radiation detector 300 also comprises four interrogation circuits 360. Each interrogation circuit 360 is associated with one of the switches 320, 330, 340, 350 and operates as described above with respect to radiation detector 100, so that a determination of the state of each switch can be made when necessary. The interrogation circuits are connected to a processor 370 operable to determine the state of the switches. The processor may be further operable to determine further characteristics of the radiation exposure, such as the duration of the exposure, dependent on the number of switches in the second state.

Detector 300 provides an indication of the duration for which it is exposed to radiation above the threshold level through the number of the switches that have been triggered to move to their second state. If, for example, only one of the switches has been triggered, the duration of exposure has been relatively short. If all the switches have been triggered, the duration of exposure will have been relatively long. It will further be appreciated that it will be possible to include a larger number of switches in the detector 300 than the four as described above, so as to enable the detector to provide information about longer exposures. It may also be desirable in some applications for the threshold voltages of the switches in detector 300 to vary. For example, the first threshold voltage may be relatively high, so that only a high energy incident will trigger the detector, whilst the remaining switches may have a relatively lower threshold voltage, so as to determining duration of exposure.

Whilst a number of specific embodiments of the invention have been described above, those skilled in the art will appreciate that variations and modifications to those embodiments are possible. For example, whilst it has been described in the above to use a MEMS switch, it will be appreciated that many of the benefits of the invention can be achieved using any switch that can be triggered at a predetermined voltage to move from a first state to a second state, provided that the switch will remain in the second state for an extended period of time, or indefinitely, without further operator input. Preferably, therefore, the switch is non-volatile. The switch is also preferably radiation hard. A radiation hard switch will not be damaged by exposure to ionising radiation; and is unlikely to change state as a result of exposure to ionising radiation. For example, many different types of low energy relay circuit can be used to trigger a larger switch, or a latch circuit could be used. It may also be possible to use magnetorsistive RAM, other types of radiation hard non-volatile RAM, or radiation hard FLASH memory. Such switches may require a power supply in order to work. However the power requirements are expected to be low and therefore relatively easily provided over a long duration, for example using a power source included in the radiation sensitive apparatus, or using an additional source, such as solar power.

Moreover, whilst a variety of combinations of radiation detectors such as radiation detector 100 and radiation detector 300 have been described above, it should be noted that other applications of combinations of the detectors will be possible. The detectors may be combined in a number of ways, for example with different types of detector arranged in combination so as to enable logic calculations relating to characteristics of the radiation. The different types of detector may comprise conversion materials with different doping characteristics, or switches with different threshold voltages, or different sizes of conversion material, or a combination of some or all of these variations. Detectors of the same or different type can also be logically combined to create voting systems to determine with greater confidence whether or not a particular level of exposure to radiation has occurred.

It will further be appreciated that other components may be included in the radiation detector circuit in dependence on the particular application for which the detector is to be used. For example, in some cases it may be desirable to include a capacitor between the conversion device and the switch. The capacitor acts to smooth any sudden variations so that, for example, a voltage spike caused by an intense but brief burst of radiation would not trigger the switch. A high capacitance would have a greater smoothing effect. It is likely that a capacitor would be accompanied by a bleed resistance to allow its charge to drain.

Finally, it should be clearly understood that any feature described above in relation to any one embodiment may be used alone, or in combination with other features described, and may also be used in combination with one or more features of any other of the embodiments, or any combination of any other of the embodiments.

1. A radiation detector comprising:
(a) a conversion device configured to develop a voltage when subject to incident radiation;
(b) a first switch configured to move between a first state and a second state when triggered by a threshold voltage;
wherein the conversion device is connected to the first switch such that, when the threshold voltage is developed across the conversion device, the first switch is triggered to move from the first state to the second state; and
(c) an interrogation circuit operable to determine whether the first switch is in the first state or the second state, thereby to determine whether the radiation detector has been subjected to a threshold level of radiation associated with the threshold voltage.

2. A radiation detector as claimed in claim 1, wherein the first switch is a MEMS switch.

3. A radiation detector as claimed in claim 1, wherein the first switch comprises a latching circuit.

4. A radiation detector as claimed in claim 1, wherein the first switch comprises a relay circuit.

5. A radiation detector as claimed in claim 1, wherein the conversion device and the first switch are operable without any further source of electrical power, and wherein the interrogation circuit is operable, when connected to a source of electrical power, to determine whether the radiation detector has been subjected to the threshold level of radiation whilst the interrogation circuit has not been connected to electrical power.

6. A radiation detector as claimed in claim 1, further comprising a second switch configured to move between a first state and a second state when triggered by a threshold voltage, the second switch being connected to the conversion device via the first switch when the first switch is in the second state; and the radiation detector further comprising a second interrogation circuit operable to determine whether the second switch is in the first state or the second state.

7. An apparatus comprising a plurality of radiation detectors as claimed in claim 1.

8. The apparatus as claimed in claim 7, wherein each of the plurality of radiation detectors is configured to have a different threshold voltage.

9. The apparatus as claimed in claim 7, further comprising a processor in communication with the interrogation circuit of each radiation detector, and configured to determine further characteristics of the radiation exposure in dependence on a state of the first switch determined by the interrogation circuit of each radiation detector.

10. The apparatus as claimed in claim 9, wherein the further characteristics comprise one or more of the duration of the exposure to radiation, and the type of radiation.

11. (canceled)

12. A system comprising the radiation detector of claim 1, and a radiation sensitive apparatus, the system being configured such that, if the interrogation circuit determines that the radiation detector has been subject to the threshold level of radiation, the radiation sensitive apparatus is disabled.

13. The system of claim 12, wherein the radiation detector is located adjacent to the radiation sensitive apparatus.

14. A radiation detector as claimed in claim 6, further comprising a processor in communication with the interrogation circuit and the second interrogation circuit of the radiation detector, and configured to determine further characteristics of the radiation exposure in dependence on a state of the first switch and a state of the second switch determined by the interrogation circuit and the second interrogation circuit, respectively.
